(19) United States
(12) Patent Application Publication
(10) Pub. No.: US 2026/0073814 A1
(43) Pub. Date: Mar. 12, 2026

(54) BREAST SIMULATION DEVICES AND MANNEQUIN ADAPTERS

(71) Applicant: REVIVEHER LLC, Sammamish, WA (US)

(72) Inventors: Deeya Sharma, Sammamish, WA (US); Nikhita Vaddineni, San Jose, CA (US)

(73) Assignee: REVIVEHER LLC, Sammamish, WA (US)

(21) Appl. No.: 19/314,219

(22) Filed: Aug. 29, 2025

Related U.S. Application Data
(60) Provisional application No. 63/691,523, filed on Sep. 6, 2024.

(51) Int. Cl. G09B 23/28; G09B 23/34

(52) U.S. Cl. CPC G09B 23/288; G09B 23/34

(57) ABSTRACT

Breast simulation devices and mannequin adapters. The breast simulation devices include a containment structure and a valve. The containment structure encloses an interior volume for holding a fluid, and the containment structure has a non-uniform thickness when viewed cross-sectionally. The valve is configured to (i) enable the fluid to be added to the interior volume and (ii) enable the fluid to be removed from interior volume. The mannequin adapters are configured to (i) be affixed to a medical mannequin and (ii) house one or more breast simulation devices.

### RELATED APPLICATIONS

This application claims benefit of U.S. Provisional Patent Application No. 63/691,523, filed on Sep. 6, 2024, which is incorporated herein by reference.

### BACKGROUND

Cardiopulmonary resuscitation (CPR) is an emergency medical procedure performed on a person who is in cardiac arrest that combines chest compressions with artificial ventilation to manually preserve brain function until further measures can be taken to restore blood circulation and breathing in the person. CPR is vital skill that can save lives in emergency situations, and it is therefore recommended that everyone be trained to perform CPR.

A National Institutes of Health (NIH)-supported study showed sex-based differences in the chances of survival from people who received bystander cardiopulmonary resuscitation (CPR) for out-of-hospital cardiac arrest. Researchers analyzed 623,342 cases of cardiac arrest in the United States between 2013-2022. Among those cases, 58,098 people, almost 1 in 10, survived. About 40% of adults who experienced cardiac arrest received CPR from a bystander who was not part of the emergency response team. This could have included a family member, friend, or member of the public. On average, those who received bystander CPR had a 28% greater chance at surviving compared to people who did not receive bystander CPR. They were also more likely to survive without having serious brain injuries. Average survival benefits for cardiac arrest, when the heart suddenly stops beating, could be twice as high for men compared to women (Blewer A L, McGovern S K, Schmicker R H, May S, Morrison L J, Aufderheide T P, Daya M, Idris A H, Callaway C W, Kudenchuk P J, et al; Resuscitation Outcomes Consortium (ROC) Investigators). When analyzed by sex, men and women who received bystander CPR had a respective 35% and 15% increased odds of surviving (Chan PS, Girotra S, Blewer A, et al. Race and sex differences in the association of bystander CPR for cardiac arrest. Circ. 2024).

Understanding public perceptions of why women who suffer an out-of-hospital cardiac arrest receive bystander cardiopulmonary resuscitation (CPR) less often than men is a necessary first step toward equitable application of this potentially life-saving intervention (Perman SM, Shelton SK, Knoepke C, Rappaport K, Matlock DD, Adelgais K, Havranck EP, Daugherty SL. Public Perceptions on Why Women Receive Less Bystander Cardiopulmonary Resuscitation Than Men in Out-of-Hospital Cardiac Arrest. Circulation. 2019 Feb. 19;139 (8)). In response, CPR training awareness and programs have expanded nationally, as have online courses.

### BRIEF DESCRIPTION OF THE DRAWINGS

FIG. 1A is top perspective view of a breast simulation device, according to an embodiment.

FIG. 1B is a bottom plan view of the FIG. 1A breast simulation device.

FIG. 1C is a cross sectional view of the FIG. 1A breast simulation device taken along line 1C-1C of FIG. 1A.

FIG. 1D is a side elevational view of the FIG. 1A breast simulation device.

FIG. 1E is a cross sectional view of the FIG. 1A breast simulation device taken along line 1E-1E of FIG. 1D.

FIG. 2A is a bottom plan view of an embodiment of the FIG. 1A breast simulation device further including an attachment device.

FIG. 2B illustrates the FIG. 2A breast simulation device being attached to a mannequin via the attachment device.

FIG. 3A is a top perspective view of a mannequin adapter, according to an embodiment.

FIG. 3B is a bottom perspective view of the FIG. 3A mannequin adapter.

FIG. 3C is a bottom perspective view of an alternate embodiment of the FIG. 3A mannequin adapter including only a single pocket.

FIG. 3D illustrates the mannequin adapter of FIG. 3A installed on a medical mannequin.

FIG. 4A is a top perspective view of another mannequin adapter, according to an embodiment.

FIG. 4B illustrates the FIG. 4A mannequin adapter installed on a medical mannequin.

FIG. 5A is a top perspective view of another mannequin adapter, according to an embodiment.

FIG. 5B is a bottom perspective view of the mannequin adapter in FIG. 5A.

FIG. 5C illustrates the FIG. 5A mannequin adapter installed on a medical mannequin.

TABLE OF FIGURE LEGENDS

| Reference No. | Description |
|---|---|
| 100 | Breast simulation device |
| 200 | Breast adapter-direct attachment of simulation |
| | device to medical mannequin |
| 300 | Mannequin adapter-Band |
| 400 | Mannequin adapter-Garment |
| 500 | Mannequin adapter-Halter |

### DETAILED DESCRIPTION OF THE EMBODIMENTS

It should be understood that various alternatives to the embodiments disclosed herein may be employed. It is to be understood that unless otherwise indicated this disclosure is not limited to particular materials, components, or manufacturing processes, as such may vary. It is also to be understood that the terminology used herein is for purposes of describing particular embodiments and is not intended to be limiting. It should be noted that, as used in the specification and the appended claims, the singular forms “a,” “an” and “the” include plural referents unless the context clearly dictates otherwise. Thus, for example, reference to “a component” includes a single component as well as a combination or mixture of components.

In cases of sudden cardiac arrest, pivotal factors that determine survival rates are immediate recognition of the cardiac arrest and early cardiopulmonary resuscitation (CPR). Unfortunately, a study has revealed shocking gender disparities in CPR provisioning. In particular, the study found that only 39 percent of women received CPR in response to cardiac arrest while 45 percent of men received CPR in response to cardiac arrest. Furthermore, a study found that outcomes after CPR were notably poorer for women than for men. Accordingly, comprehensive and inclusive CPR training is needed to improve access to CPR and outcomes after CPR.

However, conventional medical mannequins are not conducive to teaching how to perform CPR on a woman. In particular, conventional medical mannequins mimic male features, with flat chests and a body proportionate to a male. As such, conventional medical mannequins overlook anatomical distinctions that can significantly impact CPR efficacy and comfort level of someone performing CPR. Accordingly, lack of medical mannequins representative of a woman's body poses a substantial barrier to inclusive CPR training.

Disclosed herein are new breast simulation devices and mannequin adapters which address the above-discussed problems. The new breast simulation devices and mannequin adapters advantageously enable conventional medical mannequins to be adapted to a female anatomy, such as to facilitate training of how to perform CPR training on a woman. Additionally, particular embodiments are capable of realistically simulating a women's breasts, thereby further facilitating realistic CPR training. Furthermore, some embodiments are capable of simulating multiple sizes of breasts. Moreover, certain embodiments are capable of being used with essentially any conventional medical mannequin, thereby promoting versatility of the new simulation devices and mannequin adapters. Accordingly, the new breast simulation devices and mannequin adapters significantly facilitate inclusive CPR training.

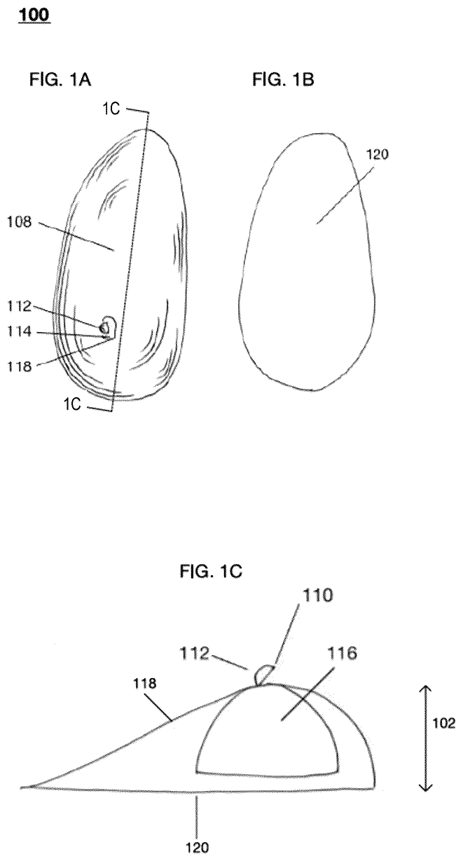

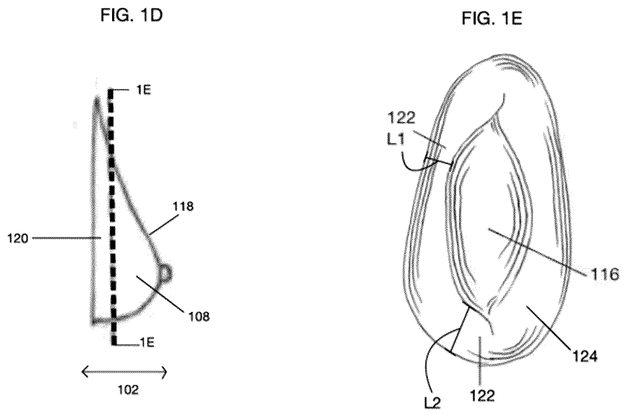

FIGS. 1A-1E collectively illustrate a breast simulation device 100, which is an embodiment of the new breast simulation devices disclosed herein. As discussed below, breast simulation device 100 simulates a human female breast, and one or more instances of breast simulation device 100 may be directly or indirectly affixed to a medical mannequin, such as to adapt the medical mannequin to a female anatomy. FIG. 1A is a top perspective view of breast simulation device 100, FIG. 1B is a bottom plan view of breast simulation device 100, FIG. 1C is a cross sectional view of breast simulation device 100 taken along line 1C-1C of FIG. 1A, FIG. 1D is a side elevational view of breast simulation device 100, and FIG. 1E is a cross-sectional view of breast simulation device 100 taken along line 1E-1E of FIG. 1D.

Breast simulation device 100 includes a containment structure 108, a valve 110, an optional simulated nipple 112, and an optional simulated areola 114. Containment structure 108 is formed, for example, of a flexible material, such as a flexible silicone material, a flexible rubber material, a flexible plastic material, and/or a flexible metallic material. Containment structure 108 encloses an interior volume 116 for holding a fluid, such as air, water, oil, or a gel, within breast simulation device 100. Accordingly, breast simulation device 100 is hollow. Containment structure 108 has shape that simulates a shape of a human female breast when interior volume 116 contains sufficient fluid, such as sufficient air, water, oil, or gel. Each of optional simulated nipple 112 and optional simulated areola 114 is disposed on a top outer surface 118 of containment structure 108. While breast simulation device 100 is depicted as having an oval cross-sectional shape in FIG. 1E, breast simulation device 100 could have a different cross-sectional shape, such as a circular cross-sectional shape or an irregular cross-sectional shape, without departing from the scope hereof.

Valve 110 is configured to enable a fluid to be added to interior volume 116, such as to increase the size of breast simulation device 100. Additionally, valve 110 is configured to enable fluid to be removed from interior volume 116, such as to decrease the size of breast simulation device 100. Further, valve 110 is configured to prevent flow of fluid into interior volume 116, as well as to prevent flow of fluid out of interior volume 116, when valve 110 is closed. Valve 110 is formed, for example, of plastic, silicon, rubber, and/or metal. Examples of valve 110 include, but are not limited to, a ball valve, a diaphragm valve, a check valve, a butterfly valve, a globe valve, a needle valve, a pinch valve, an ancilliarly tube, etc. Valve 110 is depicted as being in the vicinity of optional simulated nipple 112, and in some embodiments, valve 110 forms some, or all, of optional simulated nipple 112 and/or optional simulated arcola 114, as well as performs the fluid control functions discussed above. However, it is understood that valve 110 could be disposed at other locations on containment structure 108, such as on bottom outer surface 120 of containment structure 108. Bottom outer surface 120 is separated from top outer surface 118 in a first direction 102, as shown in FIG. 1C and FIG. 1D.

Importantly, containment structure 108 has a non-uniform thickness 122, as seen when breast simulation device 100 is viewed cross-sectionally in first direction 102, as illustrated in FIG. 1E. For example, FIG. 1E illustrates locations L₁ and L₂ on a cross-sectional periphery 124 of containment structure 108, where locations L₁ and L₂ are on different respective sides of containment structure 108. Thickness 122 at location L₁ on cross-sectional periphery 124 is different from thickness 122 at location L₂ on cross-sectional periphery 124. Specifically, thickness 122 at location L₁ is less than thickness 122 at location L₂. Applicant has found that the variation in thickness 122 along cross-sectional periphery 124 helps breast simulation device 100 realistically simulate a human female breast by causing breast simulation device 100 to lean to a side where thickness 122 is smallest, which mimics position of a human female breast when a female body is lying on its back. As such, breast simulation device 100 promotes realistic CPR training on a woman. Furthermore, the fact that valve 110 enables fluid to be added to interior volume 116, as well as enables fluid to be removed from interior volume 116, enables a user to change the size of breast simulation device 100 by changing the amount of fluid in interior volume 116, which further promotes realistic CPR training by enabling training with multiple breast sizes. Moreover, the fact that the size of breast simulation device 100 may be varied by changing the amount of fluid in interior volume 116 promotes versatility of breast simulation device 100, such as by enabling breast simulation device 100 to be adapted to varying sizes of medical mannequins.

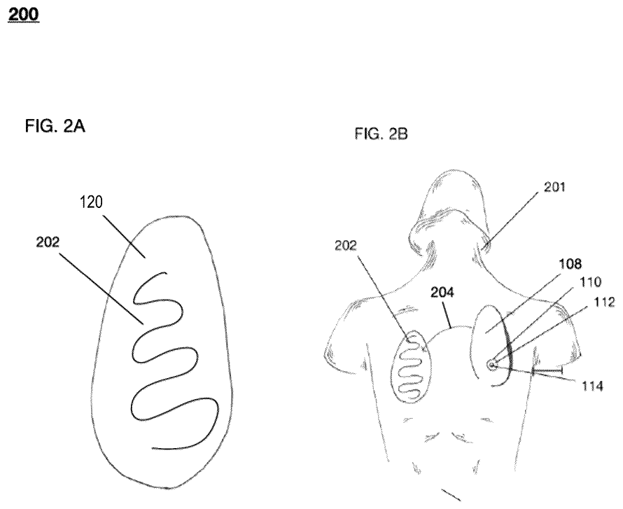

Some embodiments of breast simulation device 100 are configured to be directly attached to a medical mannequin. For example, FIGS. 2A and 2B illustrate a breast simulation device 200, where breast simulation device 200 is an embodiment of breast simulation device 100 further including an attachment device 202 for attaching breast simulation device 100 to a medical mannequin. FIG. 2A is a bottom plan view of breast simulation device 200 illustrating attachment device 202 being disposed on bottom outer surface 120, and FIG. 2B illustrates breast simulation device 200 being attached 204 to a medical mannequin 201 via attachment device 202. Attachment device 202 includes, for example, adhesive tape, one or more suction cups, one or more clips, one or more screws, one or more nails, one or more hooks, one or more clasps, one or more magnets, and/or one or more portions of a hook and loop fastener assembly, configured to facilitate attachment of breast simulation device 100 to a medical mannequin.

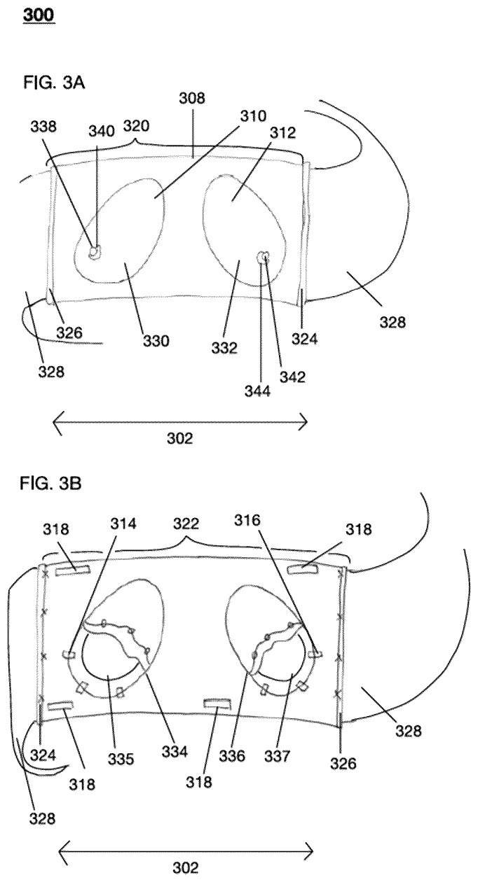

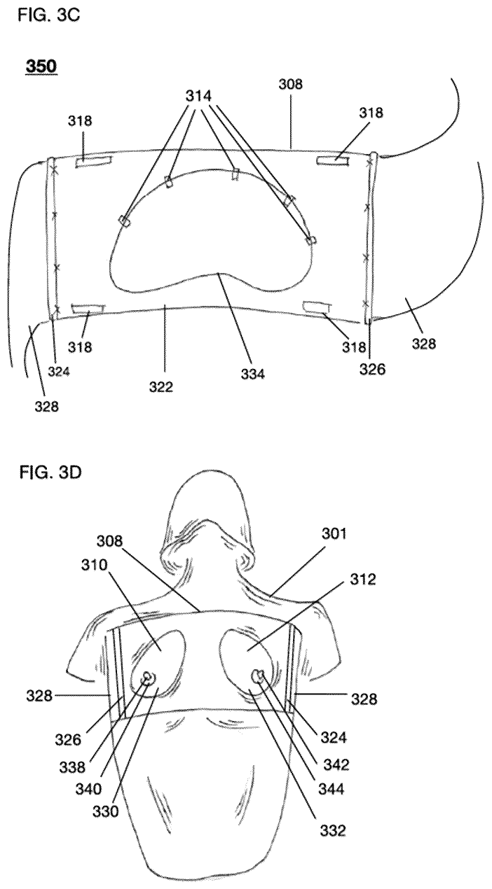

Other embodiments of breast simulation device 100 are configured to be incorporated with a mannequin adapter, where the mannequin adapter is configured to be affixed to a medical mannequin, such that one or more instances of breast simulation device 100 are indirectly affixed to the medical mannequin via the mannequin adapter. For example, FIGS. 3A and 3B collectively illustrate a mannequin adapter 300 configured to house two instances of breast simulation device 100, or other breast simulation devices, for use with a medical mannequin. Mannequin adapter 300 uses pockets to hold breast simulation device 100. Mannequin adapter 300 can use either one or multiple apertures to hold breast simulation device 100. FIG. 3A is a top perspective view of mannequin adapter 300 and FIG. 3B is a bottom perspective view of mannequin adapter 300. FIG. 3C is bottom perspective view of an alternate embodiment of mannequin adapter 300 including only a single pocket (discussed below), and FIG. 3D illustrates mannequin adapter 300 on a medical mannequin 301.

Mannequin adapter 300 includes a band 308, a first clastic compression 310, a second clastic compression 312, one or more first securing mechanisms 314, one or more second securing mechanisms 316, and one or more non-slip elements 318. Band 308 includes a top side 320 and a bottom side 322, and band 308 is elongated in a first direction 302. Band 308 has opposing ends 324 and 326 separated from each other in first direction 302. Particular embodiments of band 308 are configured to wrap completely around a medical mannequin with bottom side 322 facing the medical mannequin, to secure mannequin adapter 300 to the medical mannequin. Some embodiments of band 308 include a fastener assembly 328, e.g., a hook and loop fastener assembly, a hook and a clasp affixed to respective opposing ends 324 and 326, a pair of magnets having opposing polarities and affixed to respective opposing ends 324 and 326, one or more of buckles, adhesive tape, etc., to enable joining opposing ends 324 and 326 and thereby secure band 308 around the medical mannequin. In some embodiments, band 308 is formed of an clastic material to facilitate adaptation of band 308 to various sizes of medical mannequins.

Band 308 forms a first aperture 330 and a second aperture 332 separated from each other in first direction 302. First clastic compression 310 is attached to band 308 and covers first aperture 330 on top side 320 of band 308, such that first clastic compression 310 forms a first pocket 334 for housing a first breast simulation device 335. Second elastic compression 312 is attached to band 308 and covers second aperture 332 on top side 320 of band 308, such that second clastic compression 312 forms a second pocket 336 for housing a second breast simulation device 337. Each of the first breast simulation device 335 and second breast simulation device 337 is, for example, an instance of breast simulation device 100 of FIGS. 1A-E, a silicone breast implant, or a phantom intended for calibrating medical imaging equipment. In some embodiments, mannequin adapter 300 is provided without the first and second breast simulation devices 335 and 337, such as to enable a user to provide their own breast simulation devices.

First securing mechanisms 314 are located on bottom side 322 of band 308, and first securing mechanisms 314 are configured to (i) hold first breast simulation device 335 in first pocket 334 and (ii) enable first breast simulation device 335 to be removed from first pocket 334 from bottom side 322 of band 308, such as to enable a user to replace first breast simulation device 335 with another breast simulation device. Similarly, second securing mechanisms 316 are located on bottom side 322 of band 308, and second securing mechanisms 316 are configured to (i) hold second breast simulation device 337 in second pocket 336 and (ii) enable second breast simulation device 337 to be removed from second pocket 336 from bottom side 322 of band 308, such as to enable a user to replace second breast simulation device 337 with another breast simulation device. In some embodiments, each of first securing mechanism 314 and second securing mechanisms 316 include one or more respective clips, such as illustrated in FIG. 3B. Each of the aforementioned clips is configured, for example, to have a (i) first operating position where the clip holds breast simulation device 335 or 337 within first pocket 334 or second pocket 336, and (ii) a second operating position where the clip allows breast simulation device 335 or 337 to be placed in, or removed from, first pocket 334 or second pocket 336. In some other embodiments, each of first securing mechanism 314 and second securing mechanisms 316 includes a respective removable cover configured to be placed over first pocket 334 and second pocket 336, respectively, on bottom side 322 of band 308. In these embodiments, each cover is formed, for example, of cloth or another material that is removably attached to band 308 via a zipper, one or more buttons, etc.

The quantity and placement of first securing mechanisms 314 and second securing mechanisms 316 may vary, as long as mannequin adapter 300 includes sufficient first securing mechanisms 314 and second securing mechanisms 316 to secure respective breast simulation devices 335 and 337 in first pocket 334 and second pocket 336, respectively. Accordingly, the configuration of mannequin adapter 300 advantageously enables a user to easily replace breast simulation devices housed by mannequin adapter 300, such as to enable the user to reconfigure mannequin adapter 300 for different sizes of breast simulation devices.

First elastic compression 310 and second elastic compression 312 are formed, for example, of an elastic material that conforms to the shape of first breast simulation device 335 and second breast simulation device 337 housed in first pocket 334 and second pocket 336, respectively, to promote realistic breast simulation. The elastic material forming first elastic compression 310 and second elastic compression 312 is, for example, different from material forming band 308. Mannequin adapter 300 further includes a first simulated nipple 338 and a first simulated arcola 340 disposed on first elastic compression 310, as well as a second simulated nipple 342 and a second simulated arcola 344 disposed on second elastic compression 312, to further promote realistic breast simulation. First simulated nipple 338, second simulated nipple 342, first simulated arcola 340, and second simulated arcola 344, are formed, for example, of one or more of paint, plastic, cloth, rubber, etc.

Non-slip elements 318 are disposed on bottom side 322 of band 308, and non-slip elements 318 help prevent movement of mannequin adapter 300 on a medical mannequin. The quantity and location of non-slip elements 318 on bottom side 322 of band 308 may vary. Non-slip elements 318 are formed, for example, of a different type of material than material forming band 308, and in some embodiments, non-slip elements 318 are formed of an adhesive material to help secure mannequin adapter 300 to a medical mannequin.

FIG. 3D illustrates one example application of mannequin adapter 300 where mannequin adapter 300 is installed on medical mannequin 301. However, it is understood that mannequin adapter 300 is not limited to the FIG. 3D example application.

Mannequin adapter 300 could be modified to include a different quantity of pockets. For example, FIG. 3C is a bottom perspective view of a mannequin adapter 350, which is an alternate embodiment of mannequin adapter 300 where second aperture 332, second elastic compression 312, and second securing mechanisms 316 are omitted, such that mannequin adapter 350 is capable of housing one or multiple breast simulation devices 100 housed in a single pocket. First aperture 330 is centered on band 308 in mannequin adapter 300 due to second aperture 332 being omitted.

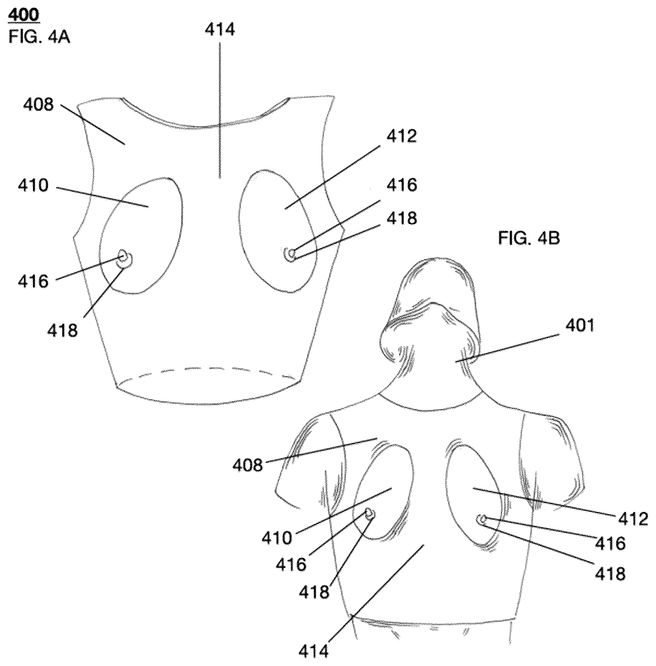

FIGS. 4A-B collectively illustrate a mannequin adapter 400, which is another embodiment of the new mannequin adapters discussed herein. FIG. 4A is a top perpsective view of mannequin adapter 400. FIG. 4B illustrates mannequin adapter 400 on a medical mannequin 401.

Mannequin adapter 400 includes a garment 408, a first pocket 410, and a second pocket 412. Garment 408 is configured to be pulled over a medical manikin, such as from the top of the medical mannequin or the bottom of the medical manikin. In some embodiments, garment 408 is similar to a T-shirt or a sweatshirt, although while not required, it is anticipated that garment 408 will typically not include sleeves. Garment 408 is formed, for example, of a stretchable material, such as a stretchable fabric. First pocket 410 and second pocket 412 are disposed on a top surface 414 of garment 408, and each of first pocket 410 and second pocket 412 is configured to house a first breast simulation device (not shown in FIGS. 4A-B) and a second breast simulation device (not shown in FIGS. 4A-B), respectively. In some embodiments, first pocket 410 and second pocket 412 are configured similarly to first pocket 334 and second pocket 336 of mannequin adapter 300, respectively. Each of the first and second breast simulation device is, for example, an instance of breast simulation device 100 of FIGS. 1A-1E, a silicone breast implant, or a phantom intended for calibrating medical imaging equipment. In some embodiments, mannequin adapter 400 is provided without the first and second breast simulation devices, such as to enable a user to provide their own breast simulation devices.

FIG. 4B illustrates one example application of mannequin adapter 400 where of mannequin adapter 400 is installed on, e.g., slid over, a medical mannequin 401. However, it is understood that mannequin adapter 400 is not limited to the FIG. 4B example application.

Mannequin adapter 400 could be modified to include a different quantity of pockets. For example, mannequin adapter 400 could be modified to include only a single pocket, such as analogous to mannequin adapter 300 as depicted in FIG. 3C. Additionally, mannequin adapter 400 could be modified so that one or more of its pockets are capable of housing two or more breast simulation devices, such as analogous to mannequin adapter 300. Furthermore, mannequin adapter 400 could be modified to omit first pocket 410 and second pocket 412 and instead be configured with one of more breast simulation devices, e.g., one or more instances of breast simulation device 100, directly attached to top surface 414 of garment 408. In these embodiments, the one or more breast simulation devices could be permanently attached to top surface 414, e.g., by sewing or glucing, or the one or more breast simulation devices could be removably attached to top surface 414, such as using a hook and loop fastener assembly, a hook and a clasp assembly, a pair of magnets, one or buckles, etc., to enable the breast simulation devices to be attached to top surface 414, and removed from top surface 414, by a user. Additionally, mannequin adapter 400 could further include one or more optional simulated nipples 416 and one or more optional simulated arcolas 418, such as illustrated in FIGS. 4A and 4B.

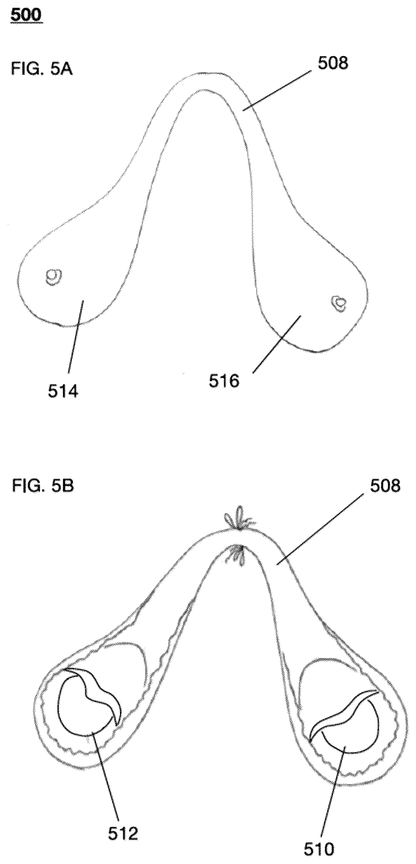

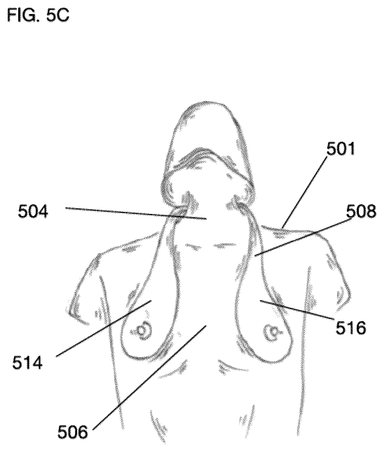

FIGS. 5A-C illustrate a mannequin adapter 500, which is an additional embodiment of the new mannequin adapters discussed herein. FIG. 5A is a top perspective view of mannequin adapter 500, and FIG. 5B is a bottom perspecitve view of mannequin adapter 500. FIG. 5C illustrates mannequin adapter 500 on medical mannequin 501.

Mannequin adapter 500 includes a halter top 508, a first breast simulation device 510, and a second breast simulation device 512. Halter top 508 has opposing ends 514 and 516. End 514 is directly or indirectly connected to first breast simulation device 510, and end 516 is directly or indirectly connected to second breast simulation device 512. Halter top 508 is configured to be worn around a neck of a medical mannequin. For example, FIG. 5C illustrates one example application of mannequin adapter 500 where of mannequin adapter 500 is installed on a medical mannequin 501 by placing halter top 508 around a neck 504 of medical mannequin 501 and each of first breast simulation device 510 and second breast simulation device 512 on a chest 506 of medical mannequin 501. It is understood, though, that mannequin adapter 500 is not limited to the FIG. 5C example application. In some embodiments, each of first breast simulation device 510 and second breast simulation device 512 includes a respective attachment device (not shown) for attaching the breast simulation device to a medical mannequin, such as medical mannequin 501. For example, in certain embodiments, each of first breast simulation device 510 and second breast simulation device 512 is embodied by an instance of breast simulation device 100 including a respective attachment device 202. First breast simulation device 510 and second breast simulation device 512 could be embodied in other manners, such as by a respective silicone breast implant or by a phantom intended for calibrating medical imaging equipment. Additionally, in particular embodiments, mannequin adapter 500 is provided without first breast simulation device 510 and second breast simulation device 512, such as to enable a user to provide their own breast simulation devices. In these embodiments, mannequin adapter 500 further includes a respective attachment device (not shown) at each of ends 514 and 516. Each attachment device includes, for example, adhesive tape, one or more suction cups, one or more clips, one or more screws, one or more nails, one or more hooks, one or more clasps, one or more magnets, and/or one or more portions of a hook and loop fastener assembly, etc.

Features from two or more of the mannequin adapters discussed above could be combined. For example, each of mannequin adapters 300 and 400 could be modified to further include an instance of halter top 508, such as assist a user in positioning and/or securing the mannequin adapter to a medical mannequin. As another example, mannequin adapter 500 could be modified to include first pocket 334 and second pocket 336 at ends 514 and 516, respectively, where first pocket 334 and second pocket 336 house first breast simulation device 510 and second breast simulation device 512, respectively.

### Combinations of Features

Features described above may be combined in various ways without departing from the scope hereof. The following examples illustrate some possible combinations.

(A1) A breast simulation device includes (1) a containment structure enclosing an interior volume for holding a fluid, the containment structure having a non-uniform thickness when viewed cross-sectionally in a first direction, and (2) a valve configured to (i) enable the fluid to be added to the interior volume and (ii) enable the fluid to be removed from interior volume.

(A2) In the breast simulation device denoted as (A1), the valve may form at least a portion of a simulated nipple of the breast simulation device.

(A3) In either one of the breast simulation devices denoted as (A1) and (A2), the containment structure may be formed of a flexible material.

(A4) In any one of the breast simulation devices denoted as (A1) through (A3), the interior volume may be at least partially filled with one or more of water, oil, and a gel.

(A5) Any one of the breast simulation devices denoted as (A1) through (A4) may further include one or more of a simulated nipple and a simulated arcola disposed on a top outer surface of the containment structure.

(A6) In any one of the breast simulation devices denoted as (A1) through (A5), (1) the containment structure may include each of a top outer surface and a bottom outer surface and (2) the top outer surface may be separated from the bottom outer surface in the first direction.

(A7) Any one of the breast simulation devices denoted as (A1) through (A6) may further include an attachment device for attaching the breast simulation device to a medical mannequin.

(B1) A mannequin adapter includes (1) a band configured to secure the mannequin adapter to a medical mannequin, the band forming a first aperture, (2) a first clastic compression covering the first aperture on a top side of the band, the first elastic compression forming a first pocket for housing at least a first breast simulation device, and (3) one or more first securing mechanisms on a bottom side of the band, the one or more first securing mechanisms being configured to (i) hold the first breast simulation device in the first pocket and (ii) enable the first breast simulation device to be removed from the first pocket from the bottom side of the band.

(B2) In the mannequin adapter denoted as (B1), the band may be configured to wrap completely around the medical mannequin.

(B3) In either one of the mannequin adapters denoted as (B1) and (B2), the band may include a fastener assembly configured to join opposing ends of the band.

(B4) In any one of the mannequin adapters denoted as (B1) through (B3), (1) the band may be formed of a first type of material and (2) the first elastic compression may be formed of a second type of material that is different from the first type of material.

(B5) Any one of the mannequin adapters denoted as (B1) through (B4) may further include a first simulated nipple disposed on the first elastic compression.

(B6) Any one of the mannequin adapters denoted as (B1) through (B5) may further include a first simulated arcola disposed on the first elastic compression.

(B7) Any one of the mannequin adapters denoted as (B1) through (B6) may further include one or more non-slip elements disposed on the bottom side of the band.

(B8) In the mannequin adapter denoted as (B7), the one or more non-slip elements may be formed of a different type material than the band.

(B9) In either one of the mannequin adapters denoted as (B7) and (B8), the one or more non-slip elements may be formed of an adhesive material.

(B10) In any one of the mannequin adapters denoted as (B1) through (B9), (1) the band further may form a second aperture, (2) the mannequin adapter further may further include a second elastic compression covering the second aperture on the top side of the band, where the second elastic compression forms a second pocket for housing at least a second breast simulation device, and (3) the mannequin adapter may further include one or more second securing mechanisms on the bottom side of the band, where the one or more second securing mechanisms are configured to (i) hold the second breast simulation device in the second pocket and (ii) enable the second breast simulation device to be removed from the second pocket from the bottom side of the band.

(B11) In the mannequin adapter denoted as (B10), (1) the band may be elongated in a first direction, and (3) the second aperture may be separated from the first aperture in the first direction.

(B12) In any one of the mannequin adapters denoted as (B1) through (B9), the first pocket may be capable housing each of the first breast simulation device and an additional breast simulation device

(B13) Any one of the mannequin adapters denoted as (B1) through (B12) may further include the first breast simulation device.

(B14) In the mannequin adapter denoted as (B13), the first breast simulation device may include (1) a containment structure enclosing an interior volume for holding a fluid, the containment structure having a non-uniform thickness when viewed cross-sectionally, and (2) a valve configured to (i) enable the fluid to be added to the interior volume and (ii) enable the fluid to be removed from interior volume.

(C1) A mannequin adapter includes (1) a garment configured to be pulled over a medical mannequin and (2) a first pocket disposed on a top surface of the garment, the first pocket being configured to house at least a first breast simulation device.

(C2) The mannequin adapter denoted as (C1) may further include a second pocket disposed on the top surface of the garment, where the second pocket is configured to house at least a second breast simulation device.

(C3) In either one mannequin adapters denoted as (C1) and (C2), the garment may be formed of a stretchable fabric.

(C4) Any one of the mannequin adapters denoted as (C1) through (C3) may further include the first breast simulation device housed in the first pocket.

(C5) In the mannequin adapter denoted as (C4), the first breast simulation device may include (1) a containment structure enclosing an interior volume for holding a fluid, where the containment structure has a non-uniform thickness when viewed cross-sectionally, and (2) a valve configured to (i) enable the fluid to be added to the interior volume and (ii) enable the fluid to be removed from interior volume.

(C6) In any one of the mannequin adapters denoted as (C1) through (C5), the first pocket may be capable housing each of the first breast simulation device and a second breast simulation device.

(D1) A mannequin adapter includes (1) a halter top having a first end and an opposing second end, the halter top being configured to be worn around a neck of a medical mannequin, (2) a first breast simulation device connected to the first end of the halter top, and (3) a second breast simulation device connected to the second end of the halter top.

(D2) In mannequin adapter denoted as (D1), the first breast simulation device may include (1) a first containment structure enclosing a first interior volume for holding a first fluid, the first containment structure having a non-uniform thickness when viewed cross-sectionally, and (2) a first valve configured to (i) enable the first fluid to be added to the first interior volume and (ii) enable the first fluid to be removed from the first interior volume.

(D3) In the mannequin adapter denoted as (D2), the second breast simulation device may include (1) a second containment structure enclosing a second interior volume for holding a second fluid, the second containment structure having a non-uniform thickness when viewed cross-sectionally, and (2) a second valve configured to (i) enable the second fluid to be added to the second interior volume and (ii) enable the second fluid to be removed from the second interior volume.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A breast simulation device, comprising:
a containment structure enclosing an interior volume for holding a fluid, the containment structure having a non-uniform thickness when viewed cross-sectionally in a first direction; and
a valve configured to:
enable the fluid to be added to the interior volume, and
enable the fluid to be removed from the interior volume.

2. The breast simulation device of claim 1, further comprising at least one of a simulated nipple and a simulated areola disposed on a top outer surface of the containment structure.

3. The breast simulation device of claim 1, wherein the containment structure is formed of a flexible material.

4. The breast simulation device of claim 1, wherein the interior volume is at least partially filled with one or more of water, oil, and a gel.

5. The breast simulation device of claim 1, wherein:
the containment structure includes each of a top outer surface and a bottom outer surface; and
the top outer surface is separated from the bottom outer surface in the first direction.

6. The breast simulation device of claim 1, further comprising an attachment device for attaching the breast simulation device to a medical mannequin.

7. The breast simulation device of claim 1, wherein the valve forms at least a portion of a simulated nipple of the breast simulation device.

8. A mannequin adapter, comprising:
a band configured to secure the mannequin adapter to a medical mannequin, the band forming a first aperture;
a first elastic compression covering the first aperture on a top side of the band, the first elastic compression forming a first pocket for housing at least a first breast simulation device; and
one or more first securing mechanisms on a bottom side of the band, the one or more first securing mechanisms being configured to (i) hold the first breast simulation device in the first pocket and (ii) enable the first breast simulation device to be removed from the first pocket from the bottom side of the band.

9. The mannequin adapter of claim 8, wherein the band is configured to wrap completely around the medical mannequin.

10. The mannequin adapter of claim 8, wherein the band further comprises a fastener assembly configured to join opposing ends of the band.

11. The mannequin adapter of claim 8, further comprising a first simulated nipple and a first simulated areola disposed on the first elastic compression.

12. The mannequin adapter of claim 8, wherein:
the band further forms a second aperture;
the mannequin adapter further comprises a second elastic compression covering the second aperture on the top side of the band, the second elastic compression forming a second pocket for housing at least a second breast simulation device; and
the mannequin adapter further comprises one or more second securing mechanisms on the bottom side of the band, the one or more second securing mechanisms being configured to (i) hold the second breast simulation device in the second pocket and (ii) enable the second breast simulation device to be removed from the second pocket from the bottom side of the band.

13. The mannequin adapter of claim 12, wherein:
the band is elongated in a first direction; and
the second aperture is separated from the first aperture in the first direction.

14. The mannequin adapter of claim 8, wherein the first pocket is capable housing each of the first breast simulation device and a second breast simulation device.

15. The mannequin adapter of claim 8, further comprising the first breast simulation device.

16. The mannequin adapter of claim 15, wherein the first breast simulation device comprises:
a containment structure enclosing an interior volume for holding a fluid, the containment structure having a non-uniform thickness when viewed cross-sectionally; and
a valve configured to:
enable the fluid to be added to the interior volume, and
enable the fluid to be removed from interior volume.

17. A mannequin adapter, the mannequin adapter comprising:
a garment configured to be pulled over a medical mannequin; and
a first pocket disposed on a top surface of the garment, the first pocket being configured to house at least a first breast simulation device.

18. The manikin adapter of claim 17, further comprising a second pocket disposed on the top surface of the garment and configured to house a second breast simulation device.

19. The mannequin adapter of claim 17, further comprising the first breast simulation device, and wherein the first breast simulation device comprises:
a containment structure enclosing an interior volume for holding a fluid, the containment structure having a non-uniform thickness when viewed cross-sectionally; and
a valve configured to:
enable the fluid to be added to the interior volume, and
enable the fluid to be removed from interior volume.

20. The mannequin adapter of claim 17, wherein the first pocket is capable housing each of the first breast simulation device and a second breast simulation device.
